(19) United States
(12) Patent Application Publication
(10) Pub. No.: US 2024/0165874 A1
(43) Pub. Date: May 23, 2024

(54) METHOD FOR THE ADDITIVE MANUFACTURING OF A COMPONENT, USING AT LEAST ONE VOLUME CHAMBER THAT IS TO BE FILLED WITH FILLER MATERIAL

(71) Applicant: AIM3D GMBH, Rostock (DE)

(72) Inventors: Clemens Lieberwirth, Rostock (DE); Vincent Morrison, Krakow am See (DE)

(73) Assignee: AIM3D GMBH, Rostock (DE)

(21) Appl. No.: 18/550,043

(22) PCT Filed: Mar. 10, 2022
(86) PCT No.: PCT/EP2022/056173

§ 371 Date: Sep. 11, 2023

(30) Foreign Application Priority Data
Mar. 12, 2021 (DE) 10 2021 106 037.0

(51) Int. Cl. B29C 64/188; B22F 10/22; B22F 10/38; B22F 10/85; B22F 12/90; B29C 64/118; B29C 64/209; B29C 64/214; B29C 64/218; B29C 64/295; B29K 105/04; B33Y 10/00; B33Y 30/00; B33Y 40/00; B33Y 50/02

(52) U.S. Cl. CPC B29C 64/188; B22F 10/22; B22F 10/38; B22F 10/85; B22F 12/90; B29C 64/118; B29C 64/209; B29C 64/214; B29C 64/218; B29C 64/295; B33Y 10/00; B33Y 30/00; B33Y 40/00; B33Y 50/02; B22F 2998/10; B29K 2105/04

(57) ABSTRACT

It is provided a method for the additive manufacturing of a component, wherein the component is constructed in a layered manner by means of at least one extruder of a 3D printing device. In the additive manufacture of at least one component layer of the component, by means of the at least one extruder in a first work step, initially an outer contour of the component layer is produced, which extends in a layer plane and comprises at least one outer wall which extends in an extension direction perpendicular to the layer plane and is intended for bounding a volume region at least in part, wherein at least one volume chamber that is open in an extension direction is formed within the volume region, and in at least one following, second work step, the at least one volume chamber is filled with a filler material, at least in part.

### CROSS-REFERENCE TO A RELATED APPLICATIONS

This application is a U.S. National Phase application of PCT Application Number PCT/EP2022/056173, filed on Mar. 10, 2022, which claims priority to German Application Number 10 2021 106 037.0, filed on Mar. 12, 2021. The disclosure of each aforementioned application is incorporated herein by reference in its entirety.

### TECHNICAL FIELD

The proposed solution relates in particular to a method for the additive manufacturing of a component.

### BACKGROUND

During the additive manufacture of a component using a 3D printing device, a component is constructed in a layered manner. In this case, by means of an extruder, and here in particular at least one extruder screw provided within the extruder, for example metal, ceramic and/or plastics granulate is the melted and conveyed to a print head of the extruder, in order to construct a component therefrom, in a layered manner. In practice, hitherto, in the case of 3D printing, usually solid body portions of the component to be manufactured are produced by application of printing material over the entire surface, in the respective component layer. For this purpose, the print head travels completely over the corresponding surface, in the component layer while printing material is applied continuously.

### SUMMARY

Against this background, there is still a need for improved printing strategies, and thus methods, by means of which the additive manufacture can be accelerated and/or the additive manufacture can be made more flexible in view of particular desired properties on the component to be manufactured.

This object is achieved both by means of a manufacturing method with features as described herein and by means of a 3D printing device with features as described herein.

In this case, the proposed solution provides in particular that, in the case of the additive manufacture of at least one component layer of a component to be manufactured, using at least one extruder of a 3D printing device,
in a first work step, initially an outer contour of the component layer is produced, which extends in a layer plane and comprises at least one outer wall which extends in an extension direction perpendicular to the layer plane and is intended for bounding a volume region at least in part, wherein at least one volume chamber that is open in an extension direction is formed within the volume region, and
in at least one following, second work step, the at least one volume chamber is filled with a filler material, at least in part.

In the course of the proposed manufacturing or printing method, it is thus provided to firstly print an outer contour of a component, comprising at least one volume region and at least one volume chamber that is open in an extension direction, in a layered manner, and then, only in a following, second work step, to fill the at least one volume chamber, already produced, with a filler material, at least in part. The construction of the component layer is then concluded by filling the volume chambers, for example. This includes in particular complete or also only partial filling of the at least one volume chamber with filler material. In this way, for example in a component layer which is intended to form a solid body portion on the finished component, firstly continuous extruded volume chambers can be produced comparatively quickly by the extruder travelling over a printing surface, before said chambers are filled with filler material only in a following work step. As a result, in particular an acceleration of the 3D printing method can be achieved since complete application of printing material is not necessary for producing the solid body portion.

It can thus be provided, in the course of the proposed method, to initially produce an outer contour of the component layer in a first work step, which contour extends, based on a cartesian coordinate system, in an xy-plane, and furthermore at least one outer wall which extends in the z-direction and is intended for bounding a volume region at least in part, which volume region comprises one or more volume chambers open in the z-direction.

In principle it is provided, in the proposed solution, that the at least one volume chamber, to be filled retrospectively, extends over exactly one component layer which is currently to be produced. An at least partial filling of the at least one volume chamber is thus completed before production of a following component layer (in the extension direction) for the component to be manufactured.

It can furthermore be provided that the type of application of the printing material, and the deposition thereof on a printing surface differs depending on whether on the one hand the outer contour or a volume chamber, or on the other hand a filling for a volume chamber, is produced. For example, for the production of the outer contour and a volume chamber a stranded application of printing material can be provided, while the filling of a volume chamber is carried out by means of point-wise extrusion of a larger amount of printing material (and thus filler material for a volume chamber), similar to an injection molding process.

In particular mechanical properties of the component to be manufactured can be individualized in a more targeted manner, by means of one or more provided volume chambers, for example in that one volume chamber or a plurality of volume chambers are not filled or are filled at most in part with filler material, and/or for the filler material a different printing material, applied via a print head of the at least one extruder, is used compared with for the printing of the outer contour. In the present case, it is assumed that an extruder of the printing device comprises at least one extruder screw for conveying the printing material to a print head, and the print head is designed having at least one nozzle, optionally fastened on a housing of the extruder so as to be exchangeable, for the application of the printing material.

For example, a variant of the proposed method provides that a plurality of (at least two) volume chambers are formed within the volume region, which chambers are separated from one another by means of at least one intermediate wall produced by means of the at least one extruder in the component layer. Thus, by means of a print head of the extruder, in the first work step at least one intermediate wall is produced within the volume region bounded by the outer wall. Said intermediate wall thus bounds a volume chamber for the filler material that is subsequently to be introduced.

The plurality of volume chambers can be arranged within the volume region in a predetermined pattern. Thus, a specified pattern for the volume chambers to be produced is then stored in a memory of the 3D printing device for example. Such a pattern can be variable depending on the application case and in particular the component or component portion to be manufactured.

For example, the volume chambers are formed in a regular or irregular manner, and/or arranged distributed in a regular or irregular manner, in the pattern. For example, a pattern can consist of a regular arrangement of identically formed volume chambers. Likewise, however, specification of a pattern comprising irregularly distributed and differently dimensioned volume chambers is also possible.

In a variant, at least one of the volume chambers is honeycombed or channel-like. This includes in particular the production of a honeycomb structure comprising a plurality of honeycombed volume chambers within the volume region of the component layer currently to be produced. In particular, the production of a 3D honeycomb pattern is possible, wherein the honeycombed volume chambers belonging thereto are then filled with filler material, in any case at least in part, in a following, second work step.

Alternatively or additionally, at least one of the volume chambers can be formed having a rectangular, triangular and/or annular (in particular circular annular or elliptical) base surface.

In a variant, the size and shape of the volume elements is specified for example for the highest possible component density, such that the retrospectively extruded filler material can fill the volume elements in a gap-free manner. For example, a volume chamber geometry in the manner of a three-dimensional hexagon is expedient for a printing strategy of this kind. For other volume chamber structures to be filled, however, for example the other geometries discussed above may also be advantageous.

The size and shape of the volume chambers within a component layer also makes it possible, for example, for a topologically optimized flux of force within the component to be achieved. Optionally, filling of volume chambers is carried out only in load-bearing portions of the component to be manufactured, for example. Some of the volumes produced can also be intentionally left unfilled and thus empty, in order to save weight. In particular in view of lightweight construction aspects, accordingly, in a variant, it is also possible for only some of the plurality of volume chambers to be filled (completely) with filler material. Some of the produced volume chambers thus remain empty and create cavities of defined size within the component to be manufactured.

With a view to the setting of particular mechanical and/or thermal properties of the component to be manufactured, a variant of the proposed method provides for filling a first portion of the volume chambers with a first filler material, and at least one further portion of the volume chambers with a second filler material that is different from the first filler material. It is thus possible, for example, in order to achieve different damping properties within the component to be manufactured, to propose using different filler materials for filling of the produced volume chambers. The use of another filler material can for example include at least one of the filler materials being a material having foaming properties and/or being an oscillation-damping filler material.

Alternatively or in addition, the at least one outer wall and the at least one intermediate wall are produced from the same material or different materials. With a view to the achievable speed advantages in the production, the use of exactly one material both for the production of the at least one outer wall and of the at least one intermediate wall may be expedient. With a view to providing the outer wall and an intermediate wall having different properties, in this case it can in particular also be provided for the at least one outer wall and the at least one intermediate wall to be produced having different wall thicknesses. However, different wall thicknesses can of course also be expedient in the case of an outer wall and an intermediate wall, which are produced from different materials.

In a variant, the wall thickness of the at least one outer wall is for example greater than a predetermined minimum wall thickness, wherein said minimum wall thickness for the outer wall is greater than a maximum wall thickness of the at least one intermediate wall. Thus, as a result, an intermediate wall is always thinner, by a defined amount, than an outer wall. This can be advantageous for the further extrusion process, for example in order to ensure that the outer contour always remains unimpaired by the introduced filler material, while the intermediate wall is melted, at least locally, by the retrospectively introduced filler material.

In principle, the at least one outer wall and the at least one intermediate wall can be produced using different print heads of the 3D printing device, when providing a plurality of volume chambers. For example, walls of different thicknesses can be produced in one work step, by means of the application via different print heads of a 3D printing device.

In order to achieve the highest possible strength in a solid portion of the finished component, according to a variant the filler material is introduced into the at least one volume chamber in a molten state, by means of the at least one extruder, with at least local melting of the at least one intermediate wall that is already produced and that separates a plurality of volume chambers from one another. In this case, the process parameters of the extrusion process, in particular the temperature, an application pressure and/or a flow speed of the molten filler material, as well as the material used for producing the at least one intermediate wall, the material for the filling of a volume chamber, and/or a wall thickness of the at least one intermediate wall are matched to one another for example in such a way that at least local melting of the intermediate wall, already produced, takes place by means of the molten filler material introduced into the at least one volume chamber. This in particular includes the at least one intermediate wall being melted or melted through by the introduced filler material, such that the filler material forms an integral bond with the at least one intermediate wall. If the material used for producing the at least one intermediate wall and the (filler) material used for producing a filling are identical, for example this material is matched, in terms of its melting point, its thermal properties and/or its flowability and the wall thickness of the at least one intermediate wall, such that the filler material, introduced molten, achieves at least local melting of the intermediate wall that is already produced. This results in a high-strength solid body portion in the finished component layer.

In contrast therewith, the filler material is intended to be introduced into the at least one volume chamber in a molten state, by means of the at least one extruder, without impairing the outer contour produced. In this case, for example process parameters of the extrusion process, in particular temperature, application pressure and/or flow speed of the molten filler material, as well as the material used for producing the at least one outer wall (for example, the melting point thereof) and/or a wall thickness of the at least one outer wall are matched to one another in such a way that the filler material introduced molten into the at least one volume chamber does not result in any impairment of the outer contour already produced, in particular the at least one outer wall is not deformed, broken through or destroyed by the introduced filler material. The introduction of the filler material into a volume chamber of a plurality of volume chambers thus takes place while maintaining the outer wall already produced, and the outer contour defined thereby, in the component layer currently to be manufactured.

In order to further individualize and/or optimize the component density on the finished component it can be provided that, in the extension direction, at least one further component layer for the component, comprising at least one further volume chamber, is produced by means of the at least one extruder, wherein the at least one further volume chamber is arranged
so as to be offset in a direction x or y extending perpendicularly to the extension direction, and/or
so as to be rotated about an X-axis in parallel with the x-direction, and/or
so as to be rotated about a Y-axis in parallel with the y-direction,

with respect to the at least one volume chamber of the layer located therebelow. Volume chambers arranged so as to have an offset (in particular in the extension direction) for example prevents weak points in the parting planes and prevents formation and/or growth of cracks within the component. For example, a corresponding offset is inherent in the case of a 3D honeycomb structure, and thus honeycombed volume chambers in the manner of three-dimensional hexagons. In the case of cuboid volume chambers, a corresponding offset could be achieved for example by means of different heights of the first and last cuboid rows of a corresponding component layer, in the extension direction.

In the course of a proposed method, the material used for producing the outer contour and/or the filler material may comprise a plastics material, a metal, or a ceramic as a constituent. In particular, metal, ceramic and/or plastics granulates can be fed to the extruder of the 3D printing device, in order to form the outer contour and/or a filling for a volume chamber therewith. Alternatively, for example a production using filament or in the course of Wire Arc Additive Manufacturing (WAAM) is also possible.

An aspect of the proposed solution further relates to a 3D printing device for the additive manufacturing of a component. The 3D printing device comprises, for a layered construction of the component, at least one extruder, at least one processor controlling the extruder, and at least one memory for control commands directed to the processor. In the case of a proposed 3D printing device, the memory contains (control) commands which, when executed by the at least one processor, cause the extruder, during the additive manufacture of at least one component layer for the component,
in a first work step, to initially produce an outer contour of the component layer, which extends in a layer plane and comprises at least one outer wall which extends in an extension direction perpendicular to the layer plane and is intended for bounding a volume region at least in part, and to form at least one volume chamber, which is open in an extension direction, within the volume region, and
in at least one following, second work step, to fill the at least one volume chamber with a filler material, at least in part.

In a variant, it is proposed for at least one further component layer for the component to be produced, in the extension direction, by means of the at least one extruder, wherein smoothing of the component layer, produced previously having the at least one volume chamber, is carried out, before material for forming the at least one further component layer is applied by the extruder. In this way, firstly possibly excess material of the previously produced component layer, protruding in the extension direction, in particular filler material used for filling a volume chamber, can be removed in a targeted manner prior to producing a further component layer. The smoothing can take place for example using a (still) hot nozzle of the extruder, which is provided for applying the material, and/or at least one separate smoothing element, in particular a doctor blade, a blade, a wire or a roller, which is moved along the component layer previously produced and comprising the at least one volume chamber.

A proposed 3D printing device is thus suitable in particular for carrying out a variant of a proposed manufacturing method. Features and advantages of variants of a proposed manufacturing method, explained above and in the following, thus also apply for variants of a proposed 3D printing device, and vice versa.

In a variant, the memory comprising the (control) commands can be spatially separated from the extruder of the 3D printing device. For example, the 3D printing device comprises a housing in which an extruder unit comprising at least one extruder and a printing platform for the component to be manufactured are arranged, and a computing unit accommodated inside the housing or arranged outside the housing, comprising the at least one processor and the memory. Then for example control software comprising the control commands for the extruder can be executed on the computing unit.

### BRIEF DESCRIPTION OF THE DRAWINGS

The accompanying drawings illustrate, by way of example, possible variants of the proposed solution.

FIG. 1 shows a component layer of a component that is to be manufactured by means of a variant of a proposed method, wherein in the component layer shown a defined pattern comprising volume chambers has already been produced, the volume chambers of which pattern are filled with a filler material, at least in part.

FIGS. 2A-2M show further possible patterns, by way of example, for differently shaped volume chambers which are produced on a component portion, during the additive manufacture by means of a variant of a proposed method, and are subsequently filled with filler material, at least in part.

FIG. 3 is a perspective view, corresponding to FIG. 1, of a further variant, in which volume chambers of the component layer that is currently to be produced are filled with different materials.

FIG. 4 is a plan view of a development, in which the volume chambers are filled with filler material in an offset manner according to a chequered pattern.

FIG. 4A is a sectional view of the component of FIG. 4 according to the cutting line A-A of FIG. 4.

FIG. 5 is a flow diagram of a variant of the proposed solution.

FIG. 6 shows the production of the component of FIGS. 1 and 3, comprising a component layer which was formed in a full-surface manner by means of a method known from the prior art.

### DETAILED DESCRIPTION

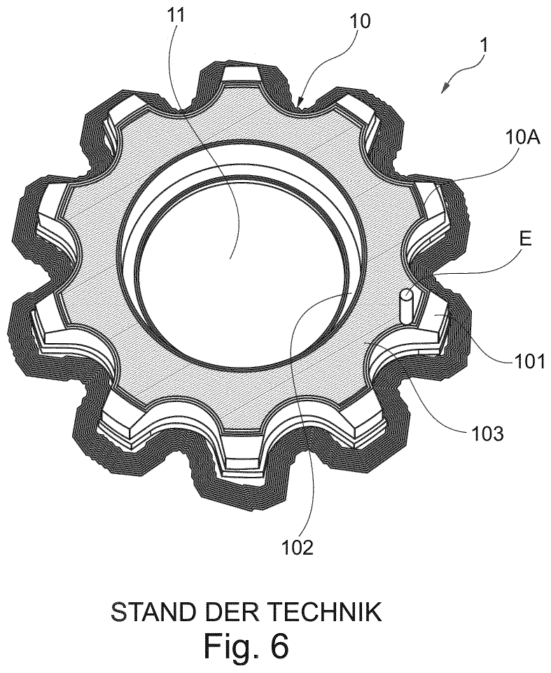

FIG. 6 shows a component in the style of a gearwheel, which is produced by means of an additive manufacturing method that is known from the prior art. In this case, the component 1 is constructed in a layered manner, for example, from a plastics material, using a 3D printing device, wherein in FIG. 6 the manufacture of one of a plurality of component layers 10 is shown. During creation of the component layer 10 shown, the plastics material used for the production is applied via a print head E of an extruder of the 3D printing device, in order, in one work step, to create both an outer contour 10A and a component portion 103 of the component layer 10 formed as a solid body portion, which is intended to be provided between two outer walls 101 and 102 of the component 1. In the present case, in the gearwheel-like component 1, the corresponding component portion 103 extends between an outer wall 101 located radially to the outside and an outer wall 102 located radially to the inside, based on a center point of the component 1, the outer wall located radially to the inside peripherally bounding a through-opening 11 of the component 1. Consequently, in order to produce the solid component portion 103 in the component layer 10, a relatively large amount of molten printing material for example plastics granulate, has to be applied over the entire surface, via the print head E. The production of the component layer 10 thus requires a relatively large amount of time. Furthermore, for example an adjustment of individual regions of the component portion 103 to different mechanical requirements is not easily possible. The proposed solution provides assistance here.

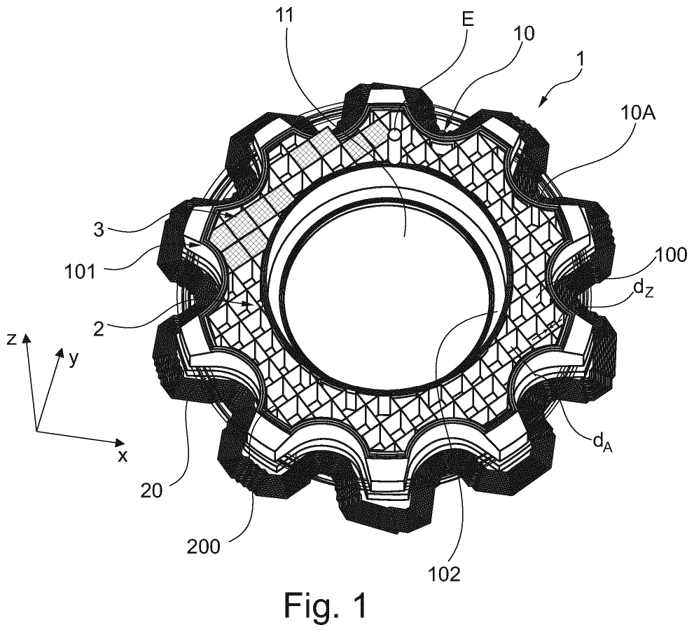

For example, it is provided in a variant according to FIG. 1 that, for the component 1, firstly in a first work step in a layer plane that in the present case coincides with an xy-plane of a cartesian coordinate system, firstly the outer contour(s) 10A of the component layer 10 that is currently to be produced, having the outer walls 101 and 102 extending in an extension direction (z-direction), are sprayed or printed. In this case, a volume region 100 present between the outer walls 101 and 102 is not filled with printing material over the entire surface area. Rather, a pattern 200 of volume chambers 2 is produced in the volume region 100 using the print head E of the 3D printing device. For this purpose, intermediate walls 200, which separate the individual volume chambers 2 from one another, are sprayed into the volume region 100 by means of the print head E.

In the variant of FIG. 1, a regular pattern 200 comprising cuboid volume chambers 2 is provided. In this case, an edge length of a cuboid of a respective volume chamber 2 in the xy-plane is smaller than a distance between one (first) outer wall 101 and the other (second) outer wall 102, which define the outer contour 10A of the component layer 10. Consequently, a pattern 200 in the manner of a honeycomb structure is produced in the volume region 100.

In a following, second work step, the produced volume chambers 2 are now filled entirely or in part with printing material, using the print head E. In this case, a filling 3 of a volume chamber 2 can be achieved using the same printing material with which the outer walls 101 and 102 were also produced. Alternatively, the (filler) material used for the filling 3 can be a different printing material. The material by which the intermediate walls 20 were produced can also be identical to or different from the material for the production of the outer walls 101, 102 and the filling.

In order to achieve the highest possible component density and a high mechanical strength, in the second work step each volume chamber 2 can be filled with filler material in a gapless manner, and thus be provided with a filling 3. Compared with the variant of FIG. 6 known from the prior art, and thus complete travel of the print head E over the entire surface area of the volume region 100 in a work step, even in the case of filling of each volume chamber 2 open in the z-direction a significant reduction of the manufacturing time for producing a solid volume region 100, and thus a continuous solid body component portion, can be achieved.

In the present case, the process parameters of the extrusion process performed are specifically adjusted, in order not to impair the outer contour 10A, already produced, by the introduction of the molten filler material into the volume chambers 2, but at the same time to in each case achieve at least local melting of the intermediate walls 20, already produced, using the molten filler material. For this purpose, in particular a wall thickness dA of the outer walls 101, 102 and a wall thickness dZ of the intermediate walls 20 are adjusted depending on the flowability and the thermal properties of the materials used in the extrusion process or the material used in the extrusion process. Thus, for example, the wall thickness dA is of such a dimension that the (filler) material retrospectively extruded into the volume chambers 2 does not deform, break or destroy the outer contour 10A. The inner intermediate walls 20, which function as dividing walls for the volume chambers 2, are in turn produced having such a small wall thickness dZ that said intermediate walls 20 are melted or even melted through by the (filler) material retrospectively extruded into the volume chambers 2. As a result, it is possible to achieve a comparatively high strength of the volume region 100 in the finished component 1.

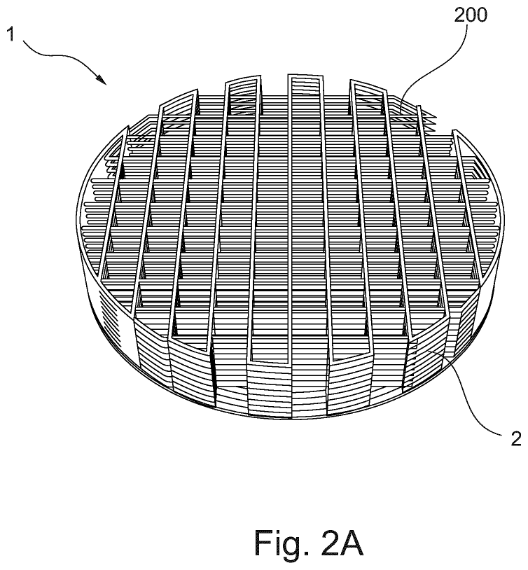

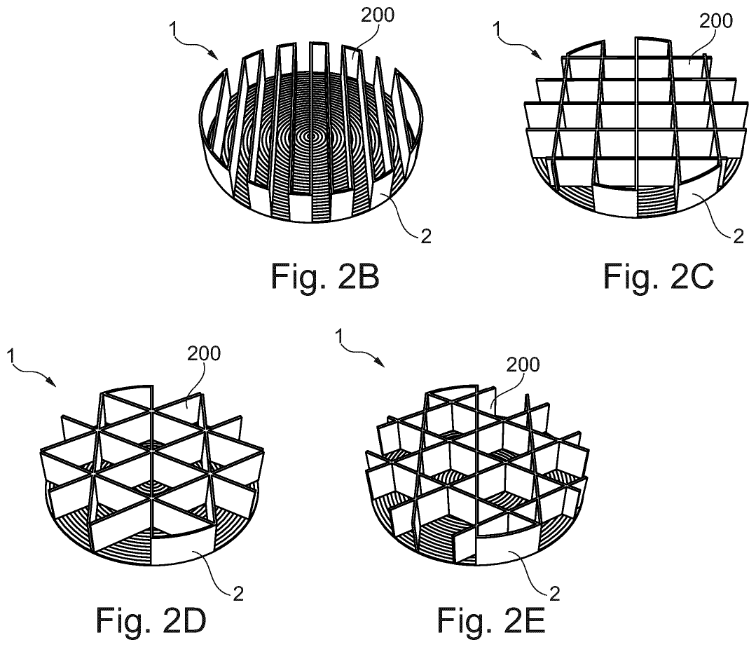

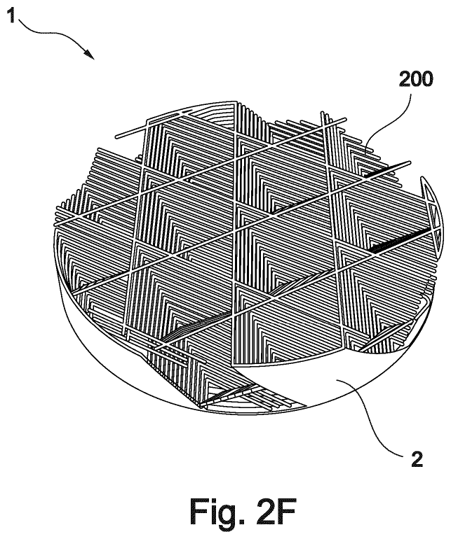

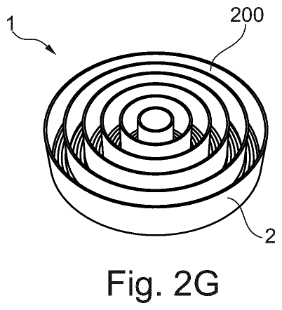

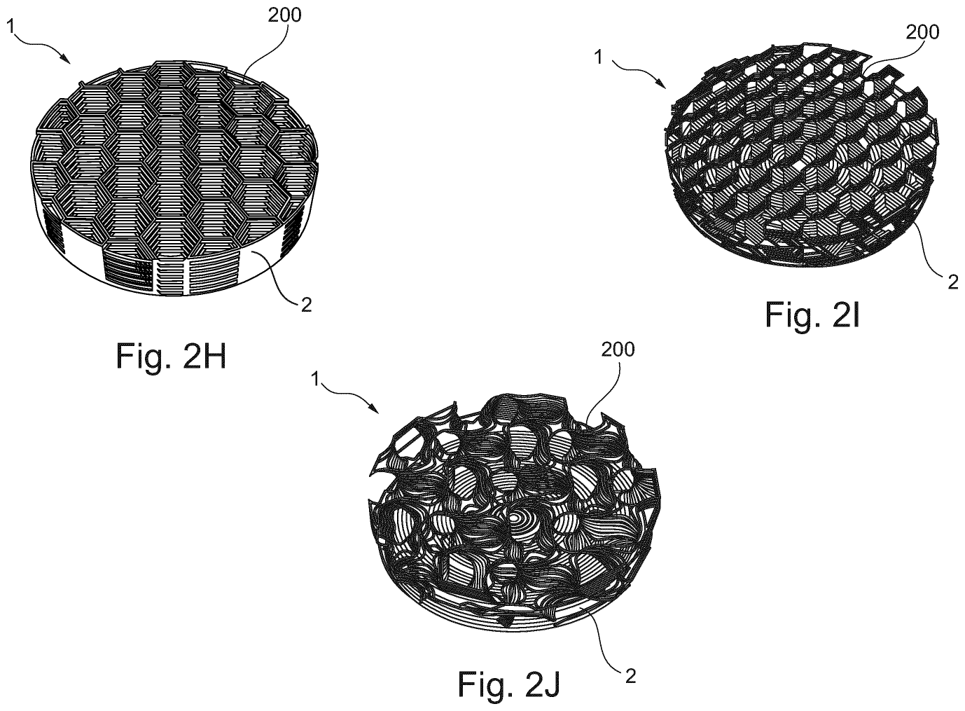

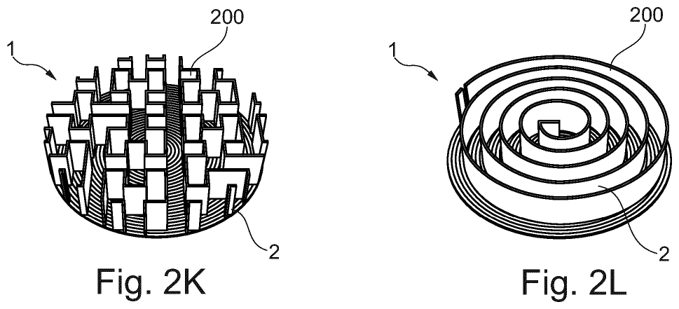

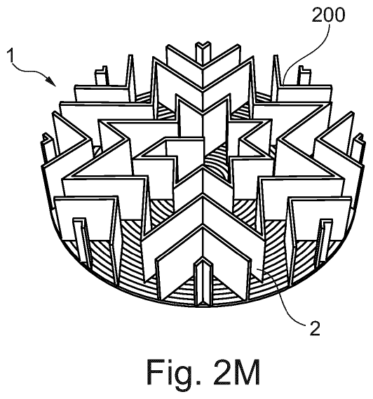

As is shown by way of example in FIGS. 2A to 2M, with reference to some examples, a pattern 200 comprising a plurality of volume chambers 2 can be designed differently, depending on the application. Thus, for example, the size and shape of the volume chambers 2 in the component layer 10 can also vary, in order to ensure optimized fluxes of force within the finished component 1. In particular, patterns 200 are conceivable in which the volume chambers 2 have a rectangular base surface, as is shown in FIGS. 2A and 2B. Likewise, mesh-like patterns 200 corresponding to FIGS. 2C, 2D and 2E, comprising volume chambers 2 having a square (FIG. 2C), triangular (FIG. 2D) or star-shaped (FIG. 2E) base surface are possible. Cuboid (FIG. 2F) or annular (FIG. 2G) volume chambers 2 are also possible in a pattern 200. This includes in particular a concentric arrangement of annular, channel-like volume chambers 2 in accordance with FIG. 2G. Honeycomb structures corresponding to the patterns 200 of FIGS. 2H and 2I are also possible. In this case, the pattern 200 of FIG. 2I represents a three-dimensional (3D) honeycomb pattern. Gyroid-shaped structures (FIG. 2J), geometries specified by a Hilbert function (FIG. 2K), spiral courses (FIG. 2L) and octagram-shaped structures and structures arranged in a spiral shape (FIG. 2M) are also possible, for forming a pattern 200 adapted to the purpose.

In this case, the volume chambers 2 of a respective pattern 200 can also remain unfilled in part, in order to provide the component 1 with well-defined inner cavities and thus form it so as to be lighter in weight.

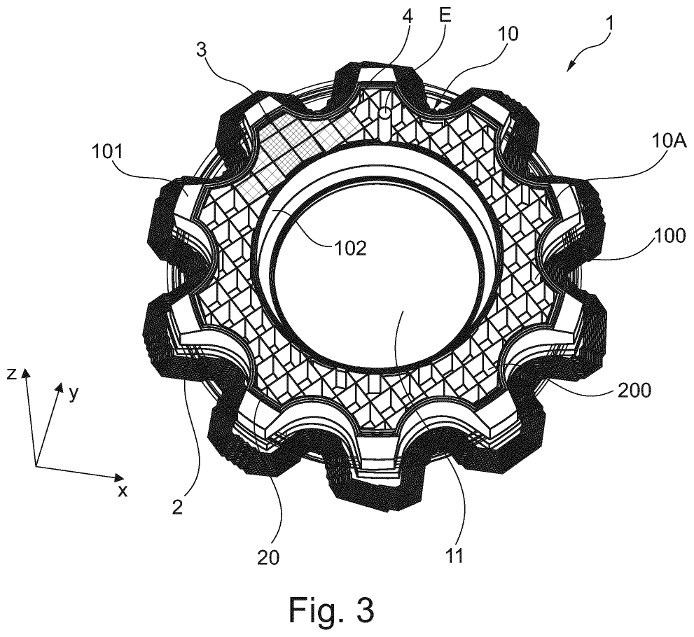

As is illustrated with reference to the variant of FIG. 3, alternatively or additionally individual volume chambers 2 can also be provided with different fillings 3 and 4. In this case, a different second filling 4 can for example be achieved using a different filler material, in order to combine particular material properties. For example, the second filler material 4 may have foaming properties and/or have an oscillation-damping effect.

In this case, it is likewise also provided in the variant of FIG. 3 that initially the outer contour 10A of the component 1 is printed, in the component layer 10 currently to be produced and having the wall thickness dA. In addition, printing takes place of an inner structure, open in the z-direction, within the volume region 100, which is composed of volume chambers 2 that are put together and may be of different shapes and sizes, wherein in this case intermediate walls 20 provided for the spatial separation of the volume chambers 2 have a smaller wall thickness dZ. In a following, second work step, the volume chambers 2 then produced in this way, for example by means of a second extruder or another print head, but optionally also by means of the same extruder or print head E, are filled with an identical printing material or another printing material and closed thereby. In this case, the process parameters of the extrusion process, in particular the material used in each case for the production of the intermediate walls 20 and the outer walls 101, 102, and the wall thicknesses dA and dZ, are matched to one another in such a way that
(a) at least local melting of the intermediate walls 20, already produced, takes place by means of the molten filler material introduced into the volume chambers 2, such that the filler material establishes an integral bond with the partially molten material of the intermediate walls 2, and
(b) no impairment of the outer contour 10A, already produced, occurs due to the molten filler material introduced into the volume chambers 2 of the volume region 100.

In a variant, it can additionally also be provided that smoothing of the component layer 10, previously produced and comprising the volume chambers 2, takes place prior to applying material for forming a further component layer. In this way, firstly possibly excess material, protruding in the z-direction, can be removed in a targeted manner prior to producing a further component layer. The smoothing can take place for example using the (still) hot nozzle of the print head E and/or at least one separate smoothing element, e.g. a doctor blade, a blade, a wire or a roller, which is moved along the component layer 10 previously produced and comprising the volume chambers 2.

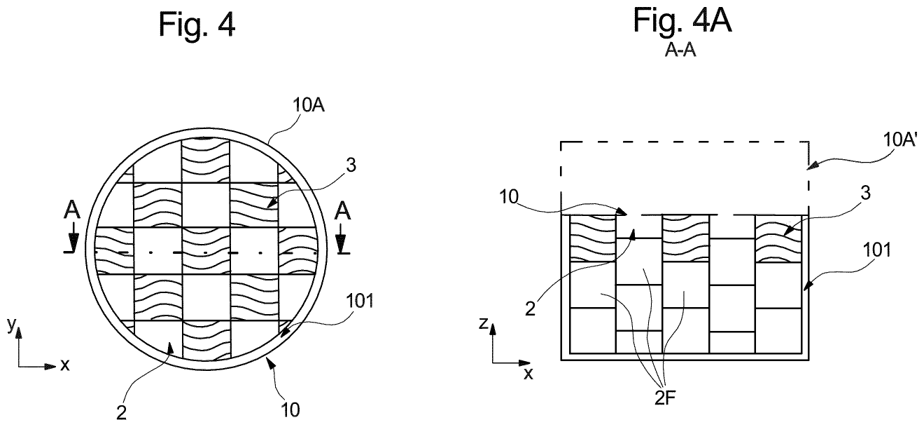

FIGS. 4 and 4A show a component layer 10 for the component 1 to be produced, in which the volume chambers 2 are filled in a manner having an offset in the z-direction, and volume chambers 2 filled in this case are arranged in a chequered pattern in the xy-plane.

FIG. 4 is a plan view of the component layer 10 comprising filled and unfilled volume chambers 2 which are arranged in a chequered pattern. As is clear in the sectional view of FIG. 4A, in this case, in the component layer 10 currently to be produced, only individual volume chambers 2 have been filled with filler material 3. These are hatched with waved lines in FIGS. 4 and 4A. Volume chambers already filled in a preceding work step are denoted in the present case by 2F. Unfilled volume chambers 2 are provided beside each volume chamber 2 filled with filler material 3 in the current component layer 10. Compared with these unfilled volume chambers 2, the currently filled volume chambers 2 are higher in the z-direction, i.e. bounded by higher intermediate walls 20 (in the present case, by way of example by approximately half a chamber height).

Following completion of the filling process, the component layer 10 is smoothed. Thereafter, the subsequent construction of a further component layer 10 takes place. For the production of said further component layer 10, the volume chambers 2 previously left unfilled (at that time still only half-height) are filled with filler material 3. The filling thereof is then followed again by smoothing in parallel with the xy-plane. This type of layered construction then takes place until a desired component height is achieved, and thus the component 1 having a final component contour 10A′, reproduced by way of example in FIG. 4A, is produced.

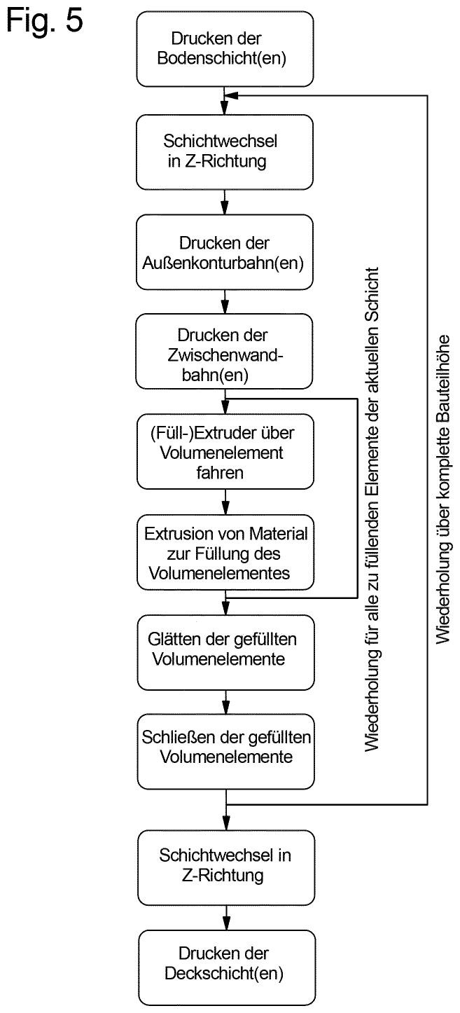

FIG. 5 is a flow diagram, by way of example, for a 3D printing method according to the proposed solution, in particular for producing a component 1 according to FIGS. 1 to 4A.

In a first step, initially at least one base layer for the component 1 to be produced is printed. Thereafter, the layered construction takes place, by producing individual component layers 10 using volume chambers 2. In this case, component layers 10 arranged one above the other in the z-direction are produced in succession, in the case of which initially the outer walls 101, 102 and intermediate walls 20 are produced in paths, and thus outer contour paths and intermediate wall paths are printed. In this case, the number of intermediate walls 20, a layer height of the component layer 10 currently to be produced, and a nozzle diameter at the print head E determine the wall thickness dZ of the intermediate walls 20.

After the production of the outer walls 101 and 102, and the intermediate walls 20, in paths, the extruder moves, with the print head E, over the individual volume chambers 2 already produced, in order to fill these. In this case, during the filling of the volume chambers 2, in particular in corner regions, the print head E of the extruder is positioned in a stationary manner, or at most a slight movement takes place. Consequently, in contrast to the production of the outer walls 101, 102 and the intermediate walls 20, no layered travel over paths takes place. Rather, in order to fill the volume chambers 2, (filler) material is extruded in a manner similar to an injection molding process, such that a volumetric, continuous filling of the volume chambers 2 takes place. In this case, the temperature and amount of the applied material have the desired influence on the cross-linking of the volume chambers 2. After completion of the filling of the volume chambers 2, to be filled, in the component layer 10 to be produced, smoothing takes place, as well as associated closure of the volume chambers 2.

In this case, the layered construction, comprising production of volume chambers 2 and the targeted filling thereof, is repeated until the intended component height of the component 1 to be produced is achieved. Subsequently, another layer change in the z-direction takes place, and printing of at least one provided cover layer for the component 1.

By means of the proposed solution, a printing strategy is provided which makes it possible to overcome layer-based weak points in a 3D printed part such as the component 1, in that larger continuous extruded volume chambers 2 are used. In this connection, it can also be provided that in each case patterns 200 of volume chambers 2 are formed in successive component layers 10 of the component 1 to be finished, wherein the volume chambers 2 of the different component layers are arranged offset with respect to one another. In particular, the volume chambers 2 can be arranged so as to be offset in the z-direction, in order to prevent weak points in the parting planes and prevent crack formation or at least crack growth at the parting planes. In a three-dimensional honeycomb structure, an offset of this kind between the honeycombed volume chambers 2 is already inherently provided. In the case of cuboid volume chambers 2, a corresponding offset would be achievable for example by means of different heights of successive first and last component layers or cuboid rows in the z-direction.

The proposed method and a 3D printing device provided for this, comprising a memory that contains corresponding control commands for actuating one or more extruders of the 3D printing device in a corresponding manner for producing the component 1 or a component layer 10 as in FIGS. 1 to 4A, can use plastics material, metal material or ceramic material. In particular, a corresponding extruder can process metal, ceramic and/or plastics granulate for producing a component 1.

### LIST OF REFERENCE CHARACTERS

1 Component
10 Component layer
100 Volume region
101 First outer wall
102 Second outer wall
103 Component portion
10A, 10A′ Outer contour
11 Through-opening
2, 2F Volume chamber
20 Intermediate wall
200 Pattern
3 Filling
4 Filling (comprising second filler material)
d_{A}, d_{Z} Wall thickness
E Print head

1. A method for the additive manufacturing of a component, wherein the component is constructed in a layered manner by means of at least one extruder of a 3D printing device, wherein
in the additive manufacture of at least one component layer of the component, by means of the at least one extruder,
in a first work step, initially an outer contour of the component layer is produced, which extends in a layer plane and comprises at least one outer wall which extends in an extension direction perpendicular to the layer plane and is intended for bounding a volume region at least in part, wherein at least one volume chamber that is open in an extension direction is formed within the volume region, and
in at least one following, second work step, the at least one volume chamber is at least partially filled with a filler material.

2. The method according to claim 1, wherein a plurality of volume chambers are formed within the volume region, which chambers are separated from one another by means of at least one intermediate wall produced by means of the at least one extruder in the component layer.

3. The method according to claim 2, wherein the plurality of volume chambers is arranged within the volume region in a predetermined pattern.

4. The method according to claim 3, wherein the volume chambers are formed and/or arranged and distributed in a regular or irregular manner in the pattern.

5. The method according to claim 2, wherein at least one of the volume chambers is honeycombed or channel-shaped.

6. The method according to claim 2, wherein at least one of the volume chambers is formed having a rectangular, triangular, and/or annular base surface.

7. The method according to claim 2, wherein only part of the volume chambers is filled with filler material.

8. The method according to claim 2, wherein a first part of the volume chambers is filled with a first filler material and at least one further part of the volume chambers is filled with a second filler material that is different from the first filler material.

9. The method according to claim 2, wherein the at least one outer wall and the at least one intermediate wall are produced from the same material or different materials.

10. The method according to claim 2, wherein the at least one outer wall and the at least one intermediate wall are produced having different wall thicknesses.

11. The method according to claim 10, wherein the wall thickness of the at least one outer wall is greater than a predetermined minimum wall thickness, which is greater than a maximum wall thickness of the at least one intermediate wall.

12. The method according to claim 2, wherein the at least one outer wall and the at least one intermediate wall are produced using different print heads of the 3D printing device.

13. The method according to claim 2, wherein the filler material is introduced into the at least one volume chamber in a molten state by means of the at least one extruder along with at least local melting of the at least one intermediate wall already produced.

14. The method according to claim 1, wherein the filler material is introduced into the at least one volume chamber in a molten state by means of the at least one extruder without impairing the outer contour already produced.

15. The method according to claim 1, wherein, in the extension direction, at least one further component layer for the component, comprising at least one further volume chamber, is produced by means of the at least one extruder, wherein the at least one further volume chamber is arranged
so as to be offset in at least one spatial direction x or y extending perpendicularly to the extension direction, or
so as to be rotated about an X-axis in parallel with the x-direction, or
so as to be rotated about a Y-axis in parallel with the y-direction,
with respect to the at least one volume chamber of the layer located therebelow.

16. The method according to claim 1, wherein, in the extension direction, at least one further component layer for the component is produced by means of the at least one extruder, and smoothing of the previously produced component layer having the at least one volume chamber is carried out before material for forming the at least one further component layer is applied by the extruder.

17. The method according to claim 16, wherein the smoothing takes place using a hot nozzle of the extruder, which is provided for applying the material, and/or at least one separate smoothing element, in particular a doctor blade, a blade, a wire or a roller, which is moved along the previously produced component layer having the at least one volume chamber.

18. The method according to claim 1, wherein at least one constituent of the material used for producing the outer contour and/or the filler material is a plastics material, a metal, or a ceramic.

19. A 3D printing device for the additive manufacturing of a component, wherein the 3D printing device comprises, for a layered construction of the component, at least one extruder, at least one processor controlling the extruder, and at least one memory, wherein
the memory contains commands which, when executed by the at least one processor, cause the extruder, during the additive manufacture of at least one component layer for the component,
in a first work step to initially produce an outer contour of the component layer which extends in a layer plane and comprises at least one outer wall which extends in an extension direction perpendicular to the layer plane and is intended for bounding a volume region at least in part, and to form at least one volume chamber which is open in an extension direction within the volume region, and
in at least one following, second work step, to fill the at least one volume chamber with a filler material, at least in part.
